(19) United States
(12) Patent Application Publication
(10) Pub. No.: US 2016/0148253 A1
(43) Pub. Date: May 26, 2016

(54) Temporal Dynamics in Display Advertising Prediction

(71) Applicant: Adobe Systems Incorporated, San Jose, CA (US)

(72) Inventors: Jaya B. Kawale, San Jose, CA (US); Sheng Li, Weymouth, MA (US)

(21) Appl. No.: 14/553,877

(22) Filed: Nov. 25, 2014

(51) Int. Cl. G06Q 30/02

(52) U.S. Cl. CPC G06Q 30/0247

(57) ABSTRACT

A temporal prediction model is described that is usable to predict user purchase behavior for an online advertising instance. The temporal prediction model may be formed by processing time windows for click data, conversion data, and side information. In one or more implementations, temporal dynamics are applied to the click data, the conversion data, and/or the side information via the processed time windows. Various processing techniques of the temporal prediction model may utilize the applied temporal dynamics to predict user purchase behavior and/or effectiveness of an online advertising instance.

### BACKGROUND

Online advertising has become an increasingly effective way to market products and services. For instance, users accessing the Internet may be presented with various advertisements. In some instances, the user may select the advertisement and/or purchase the advertised product or service. These actions by the user may be useful for predicting potential revenue of future advertisements and/or targeting advertisements to a particular user. However, predicting potential revenue of future advertisements may be challenging as users interests and purchase behavior change over time.

For example, conventional techniques may track whether a user clicks on an online ad to determine the effectiveness of the online ad. Other conventional techniques may evaluate purchase activity of a user in response to viewing an online ad. However, in some instances user clicks and purchase activity alone may not serve to accurately predict revenue associated with an online ad. In addition, prediction models centered on user clicks and purchase activity may incur high computational costs due to processing high volumes of data.

### SUMMARY

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

A temporal prediction model is described that predicts user purchase behavior for an online advertising instance. The temporal prediction model is also useful for measuring the effectiveness of the online advertising instance or selecting an online advertising instance for presentation. In one implementation, a temporal prediction model processes click and conversion data according to a time window that reflects a user's changing purchase behavior. In some instances, two or more time windows are processed by the temporal prediction model to predict whether a user is likely to purchase an item associated with a digital advertisement.

Time windows that reflect a change in user purchase behavior may be processed in a variety of ways. For instance, a temporal prediction model may apply one or more time windows to the click data and the conversion data to reduce a set of data used to make a prediction. In some instances, processing time windows by the temporal prediction model includes training the model with click and conversion data corresponding to a first time window and processing past user behavior data according to a second time window. Predictions made by the temporal prediction model may leverage additional side information corresponding to a user, an advertiser, and/or an advertisement item.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ techniques described herein.

FIG. 2 depicts a representation of a scenario in an example implementation in which the temporal prediction model makes various predictions.

FIG. 3 is a flow diagram depicting a procedure in which the temporal prediction model predicts user purchase behavior.

FIG. 4 is a flow diagram depicting a procedure for predicting a level of effectiveness for an online advertising instance based on processing data according to two time windows.

FIG. 5 is a flow diagram depicting a procedure for forming a temporal prediction model using a subset of data determined by processing multiple time windows.

FIG. 6 illustrates an example system including an example device that is representative of one or more computing systems and/or devices that may implement the various techniques described herein.

### DETAILED DESCRIPTION

Overview

A user may select an advertisement and/or purchase an advertised product or service on the Internet. These actions by the user are useful for predicting potential revenue of future advertisements, targeting advertisements to a particular user, and so on. However, predicting potential revenue of future advertisements may be challenging as users interests and purchase behavior change over time.

For example, conventional techniques track whether a user clicks on an online ad to determine the effectiveness of the online ad. Other conventional techniques evaluate purchase activity of a user in response to viewing an online ad. However, user clicks and purchase activity alone do not accurately predict revenue associated with an online ad in some instances. In addition, prediction models centered on user clicks and purchase activity alone typically involve high computational costs due to processing high volumes of data.

A temporal prediction model is described that predicts user purchase behavior for an online advertising instance. The temporal prediction model is also useful for measuring the effectiveness of the online advertising instance or selecting an online advertising instance for presentation. In one implementation, a temporal prediction model processes click and conversion data according to a time window that reflects a user's changing purchase behavior. In some instances, two or more time windows are processed by the temporal prediction model to predict whether a user is likely to purchase an item associated with a digital advertisement.

A temporal prediction model may be formed in a variety of ways. For example, a temporal prediction model may be formed by applying a temporal factor to click data and conversion data and using the temporal click data and the temporal conversion data to form the model. In an example when two time windows are processed, a temporal prediction model may be created as described above with the addition of applying a second temporal factor to user purchase behavior data. In this example, the temporal factors may correspond to time windows that are based on a temporal relationship between click data and conversion data associated with a previous online advertising instance. The temporal relationship may be representative of an identified change in user purchase behavior over a particular time period. Thus, a temporal prediction model is formed to dynamically adjust for changing user interests and/or purchase behavior over time.

Time windows that reflect a change in user purchase behavior may be processed in a variety of ways. For instance, a temporal prediction model may apply one or more time windows to the click data and the conversion data to reduce a set of data used to make a prediction. Processing time windows by the temporal prediction model includes training the model with click and conversion data corresponding to a first time window and processing past user behavior data according to a second time window. Predictions made by the temporal prediction model may also leverage additional side information corresponding to a user, an advertiser, and/or an advertisement item.

Generally, the time windows are indicative of a temporal factor such as a fixed time value. In some examples, the time window is substantially equal to the amount of time between a click or an impression of an online advertising instance and a conversion corresponding to the online advertising instance. However, in other examples, the time window is substantially equivalent to the amount of time between a click or an impression of an online advertising instance and a conversion plus some time variable. The time variable, for instance, is determined based on an average time between a set of clicks and a set of corresponding conversions. In one specific example, the time window is predefined as approximately one week, although other examples are also contemplated.

Existing approaches for conversion prediction and for click prediction look at the two problems in isolation. However there is considerable benefit in jointly solving the problems as the two goals are often intertwined. The temporal prediction model, for instance, predicts the conversion response of the users by jointly examining the past purchase behavior and the click response behavior. Additionally, the model captures the temporal dynamics between the click response and purchase activity into a unified framework. In particular, the temporal prediction model represents functionality to perform matrix factorization with temporal dynamics and therefore may be thought of as representing dynamic collective matrix factorization (DCMF).

The temporal prediction model may be configured to predict various metrics. For example, the temporal prediction model may be configured to predict user purchase behavior corresponding to an online advertising instance. Additionally or alternatively, the predicted metrics may include predicting the effectiveness of an online advertising instance, predicting whether a user will select an online advertising instance, predicting revenue from future advertisements, predicting a post-click conversion (e.g., a purchase activity after a user clicks on an advertisement), predicting a post-impression conversion (e.g., a purchase activity after a user was presented an advertisement but did not click on it), and so on. Regardless of the metric predicted, the temporal prediction model is representative of functionality that may be configured to predict user behavior corresponding to an online advertising instance and/or a subsequent online advertising instance.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

### Example Environment

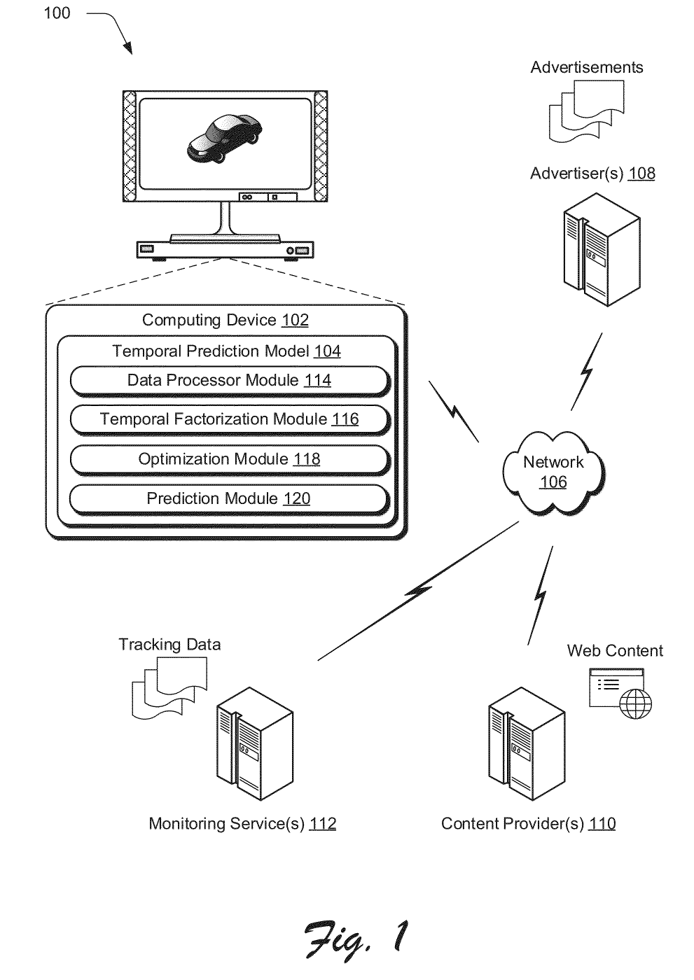

FIG. 1 is an illustration of an environment 100 in an example implementation that is operable to employ techniques described herein. The illustrated environment 100 includes a computing device 102 which comprises a temporal prediction model 104, a network 106, advertisers 108, content providers 110, and monitoring services 112. The advertisers 108, content providers 110, and monitoring services 112 may be implemented using one or more computing devices, e.g., a server farm, “in the cloud,” and so on.

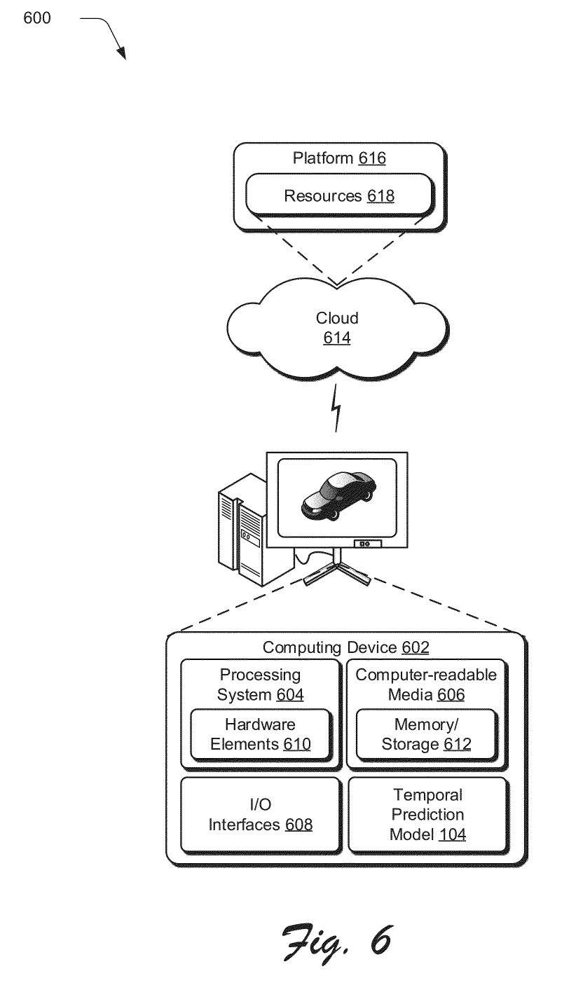

The computing device 102, for instance, may be configured as a desktop computer, a laptop computer, a mobile device (e.g., assuming a handheld configuration such as a tablet or mobile phone), and so forth. Thus, the computing device 102 may range from full resource devices with substantial memory and processor resources (e.g., personal computers, game consoles) to a low-resource device with limited memory and/or processing resources, e.g., mobile devices. Additionally, although a single computing device 102 is shown, the computing device 102 may be representative of a plurality of different devices, such as multiple servers utilized by a business to perform operations “over the cloud” as further described in relation to FIG. 6.

The temporal prediction model 104 is representative of functionality to predict user purchase behavior and/or measure effectiveness associated with an online advertising instance. As will be discussed further below, various types of data may be processed by the temporal prediction model 104 to enable predictions. For instance, data (e.g., click data and/or conversion data) for processing may be received from advertisers 108, content providers 110, and/or monitoring services 112 via network 106. Processing data may include various operations including applying a temporal factor to the data and/or filtering the data according to a particular time window. A variety of other examples are also contemplated, further discussion of which may be found in the following sections.

In one specific example, the temporal prediction model 104 may obtain tracking data, such as click data, conversion data, and user purchase data describing interaction of a user relative to an online advertising instance, from the monitoring services 112. The tracking data may correspond to an advertisement provided by advertisers 108 and may be associated with latent features of a user (e.g., user purchase behavior), an advertisement, and/or an advertisement item. In some instances, the advertisement may be presented on a display device of computing device 102 in conjunction with web content provided by a content provider 110. Predictions generated by the temporal prediction model 104 may be shared with one or more of the advertisers 108, the content providers 110, and the monitoring services 112 for purposes of clarifying an online marketing strategy.

Additional data (e.g., side information) may be utilized to leverage the temporal prediction model 104. That is, the temporal prediction model 104 may obtain and/or process the side information in addition to the tracking data. The side information may correspond to data describing a user, an advertiser/advertisement, and/or an advertisement item. User data, for instance, may describe user behavior associated with the online advertising instance (either directly or indirectly) and may include demographic information e.g., country, state, domain, and so on. Example advertiser data may describe attributes of the advertiser, such as an advertiser name, ad size, marketing strategies, and the like. Data describing an advertising item may include an item type and an item price to name a few. Processing the side information by the temporal prediction model 104 will be discussed in more detail below.

The network 106, meanwhile, represents any one or combination of multiple different types of wired and/or wireless networks, such as cable networks, the Internet, private intranets, and so forth. While FIG. 1 illustrates the computing device 102 communicating with the advertisers 108, the content providers 110, and/or the monitoring services 112 over the network 106, the techniques may apply in any other networked or non-networked architectures.

The illustrated environment 100 further includes the advertisers 108, the content providers 110, and the monitoring services 112 each of which may exchange data with the computing device 102 via the network 106. For example, the advertiser 108 and the content provider 110 may receive predictions from the computing device 102. Additionally or alternatively, the advertiser 108, the content provider 110, and/or the monitoring services 112 may send advertisements, web content, and/or tracking data to the computing device 102. In some scenarios, functionality performed by the advertiser 108, the content provider 110, and/or the monitoring services 112 may be configured to be performed by a single entity, such as the computing device 102.

Advertisements in various forms may be sent from the advertisers 108 to the computing device 102 for storage and/or presentation. An advertisement from the advertisers 108 may be selected for presentation based on the metrics predicted from the temporal prediction model 104. Consequently, advertisers 108 that receive predicted metrics may make use of the temporal prediction model 104 to improve a rate of return using the predicted metrics. For example, relative to conventional techniques, the predicted metrics determined by the temporal prediction model 104 may be useful in improving income to the advertiser 108 via conversions, purchases, subscriptions, memberships, and/or orders.

Generally speaking, a content provider 110 is configured to make various resources (e.g., content, services, web applications, etc.) available over the network 106, such as the Internet, to provide a “cloud-based” computing environment and web-based functionality to clients. For instance, the content provider 110 may provide an online advertising instance for presentation by the computing device 102. Here, the online advertising instance may be provided responsive to a search query received by the computing device 102, launching an application, a request for a webpage, or other activities performed in a user interface or browser.

The monitoring service 112 (e.g., a service utilizing analytics and/or tracking tools) may receive an inquiry from the computing device 102 and track online advertising instances associated with the inquiry. In some instances, the monitoring service 112 may send tracking data describing the online advertising instances (e.g., a displayed advertisement, a displayed webpage, a displayed search result, a promoted webpage, and so forth) to the computing device 102. In one or more implementations, the monitoring service 112 may be a third-party service that stores data that correlates impressions, clicks, costs, conversions, and so forth to a particular advertising instance and/or a particular user. Additionally or alternatively, the monitoring service 112 may store tracking data describing time spent on webpage, webpage viewed, and/or bounce rate associated with a particular advertisement.

The temporal prediction model 104 is illustrated as including a data processor module 114, a temporal factorization module 116, an optimization module 118, and a prediction module 120. By way of example and not limitation, the data processor module 114 represents functionality to process and/or receive data, such as tracking data and/or side information. In one specific example, processing of the obtained data includes identifying a temporal relationship between click data and conversion data. The temporal relationship may be identified in various manners, one example of which includes identifying a time linkage between the click data (e.g., user identifier (ID), day, ad ID, webpage ID, country, browser, advertiser ID, and/or size of ad) and the conversion data e.g., ad item ID, ad item type, day, price, and/or quantity. For instance, the time linkage may be representative of an amount of time between a click or an impression of an online advertising instance and a conversion corresponding to the online advertising instance.

The data processor module 114 may further include functionality to receive one or more time windows for processing. In some examples, the time windows are substantially equal to the amount of time between a click or an impression of an online advertising instance and a conversion corresponding to the online advertising instance. However, in other examples, the time window may be the amount of time between a click or an impression of an online advertising instance and a conversion plus some time variable. The time variable may be determined based on an average time between a set of clicks and a set of corresponding conversions. In one specific example, the time window may be predefined as approximately one week, although other examples are also contemplated.

In an alternative implementation, the data processor module 114 may receive a time window based on a change in user purchase behavior. Changes in user purchase behavior may be determined in a variety of manners, and may include determining that a user that purchased a particular item is unlikely to purchase the same item for at least a set time period. Purchase behavior data may be obtained from various sources (e.g., such as monitoring service 112) that describes the time period between purchases of related items. Thus, the time window may account for a frequency at which a user buys a particular item or related items.

Additionally or alternatively, changes in user purchase behavior may be determined by identifying a relationship between items purchased (or viewed) and items offered for sale (or sold) by a particular user. In this example, user data that describes items sold or offered for sale may be compared to other data describing items purchased or viewed. Based on the comparing, a change in user purchase behavior may be identified that indicates previous items purchased are less likely to be of interest to the user because items sold by the same user demonstrates changing user interests. That is, a user that purchased accessories for their car are less likely to do so after selling their car and buying a bus pass. Thus, in this example, the relationship between items purchased and items sold may serve as a time window that reflects actual user interests (e.g., purchases in a time frame around the buying of the bus pass) rather than relying on past purchases that are no longer of interest or relying on data describing all past purchases.

The temporal factorization module 116 represents functionality to apply temporal dynamics to the obtained data. For example, the time window (or time windows) may be used to filter the obtained data such that a subset of the obtained data is used to form predictions. In this example, click data and conversion data may be input into a collective matrix factorization (CMF) model that is modified to include a time value corresponding to the time window. Traditional CMF models fail to consider temporal dynamics and therefore utilize large data sets for training that leads to computational latency. By applying temporal dynamics to a CMF model, a subset of available data is utilized for training and predictions thereby reducing computational latency.

In some cases, multiple time windows may be considered and/or processed prior to making a final prediction. In other words, the temporal factorization module 116 may dynamically adjust to another time window to produce predictions for each time frame. Predictions generated from the multiple time windows may be compared before sending a final prediction to an advertiser. In one specific example, user purchase behavior data may be used as described above to process one of the two time windows such that the two time windows are applied by the temporal factorization module 116.

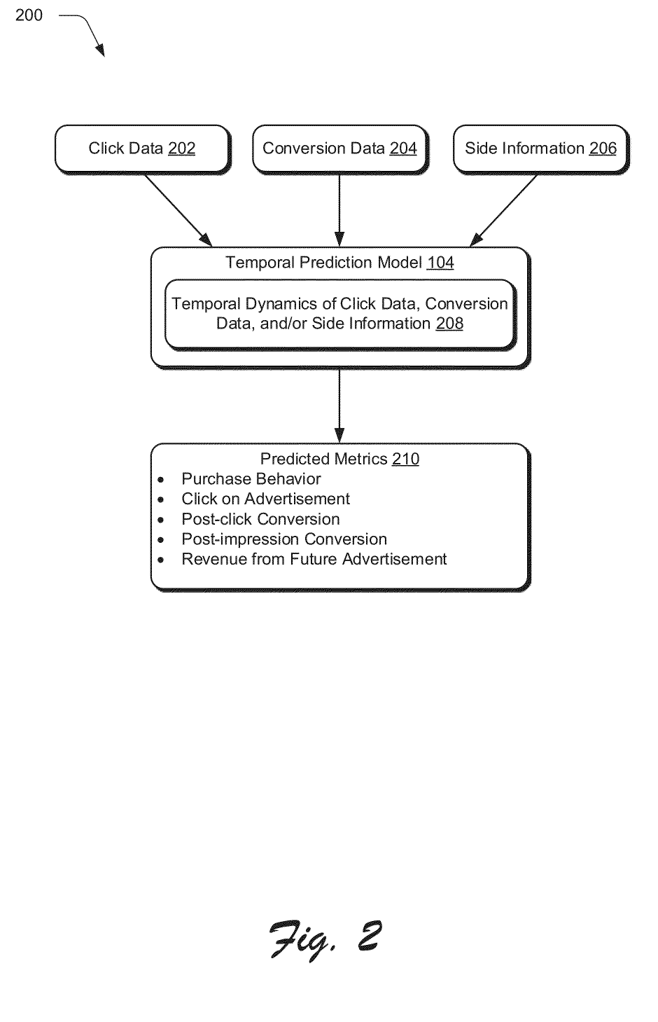

Processing multiple time windows by the temporal factorization module 116 may take various forms. For instance, a first time window is applied to the tracking data, such as the click data and the conversion data, while a second time window is applied other data, such as user purchase behavior data. By applying the time windows to the data, a subset of such data is selected for processing that leads to a prediction. In one specific example, the first and second time windows are processed in parallel using one or more of the example algorithms described in FIG. 2.

In some examples, the first and second time windows are a same duration of time (e.g., a week) whereas for other datasets the first and second time windows may be of different duration. The second time window may be thought of as being associated with the first time window because in some instances, the second time window represents a time frame occurring prior to the first time window. That is, in examples when the first time window is approximately one week, the second time window is the preceding week. In this way, the first and second time windows may represent two consecutive time frames.

An optimization module 118 implements functionality for improving predictions by processing side information in addition to the tracking data mentioned above. In one scenario, the CMF model modified to include temporal dynamics may be further modified to include the side information data describing a user, an advertiser, and/or an advertisement item. To process the side information, a stochastic gradient descent algorithm may be applied to the previously processed data e.g., click data and the conversion data. FIG. 2 goes into greater detail with regard to the functions that process the tracking data and side information.

The prediction module 120 forms predictions based on the obtained data (e.g., tracking data and/or side information). As previously mentioned, example predictions may include one or more of user purchase behavior corresponding to an online advertising instance, the effectiveness of an online advertising instance, whether a user will select an online advertising instance, and so on.

Although the temporal prediction model 104 is illustrated as being implemented on the computing device 102 it should be readily apparent that other implementations are also contemplated in which the temporal prediction model 104 is implemented on a separate device such as a remote server, a local server, or other remote computing device such as the advertisers 108, the content providers 110, and/or the monitoring services 112. Regardless of where implemented, the temporal prediction model 104 is representative of functionality that may be configured to predict user purchase behavior and/or measure effectiveness associated with an online advertising instance.

FIG. 2 depicts generally at 200 a representation of a scenario in an example implementation in which the temporal prediction model 104 of FIG. 1 makes various predictions. As represented in FIG. 2, click data 202, conversion data 204, and side information 206 are received by the temporal prediction model 104 which applies temporal dynamics to the data and forms predicted metrics 210. The click data 202, the conversion data 204, and the side information 206 may correspond to the descriptions of such data in FIG. 1 and elsewhere. The conversion data 204 includes user purchase behavior data in some examples while in other examples the user purchase behavior data may be obtained as separate tracking data. Further, the click data 202 may be considered a positive instance (and therefore be represented as a positive value) responsive to determining that a user clicked an advertisement after viewing it. Alternatively, the click data may be considered a negative instance (and therefore be represented as a negative value) responsive to determining that the user did not click an advertisement after viewing it. In addition or alternatively, the conversion data 204 may be considered a positive instance responsive to the user performing a conversion or a negative instance responsive to the user not performing a conversion. Thus, the conversion data 204 may be represented as a positive or negative value depending on an action by the user.

Table 1 includes descriptions for notations that are used below in example algorithms to employ temporal dynamics.

TABLE 1

| Notation | Description |
|---|---|
| C | Binary click response matrix |
| D | Binary purchase activity matrix |
| U | Latent features of users |
| V | Latent features of advertisements |
| P | Latent features of items |
| M | Transition matrix |
| X | Side information of users |
| Y | Side information of advertisements |
| Z | Side information of items |
| Û | Regression coefficients of users |
| \hat{V} | Regression coefficients of advertisements |
| \hat{P} | Regression coefficients of items |

Notation ‘C’ may be formed from click data while notation ‘D’ may be formed from conversion data. The latent features of notations ‘U’, ‘V’, and ‘P’ correspond to existing features of users, advertisements, and advertising items, respectively and are commonly associated with a click response and/or purchase activity. The transition matrix ‘M’ captures user behavior (e.g., user purchase behavior) in at least two successive time slices ‘t’. ‘T’ meanwhile represents a pre-defined number of time slices. The side information of ‘X’, ‘Y’, and ‘Z’ may correspond to the side information described in relation to FIG. 1 and elsewhere. Further notations include ‘i’ to represent a particular user, ‘j’ to represent a particular advertisement, and ‘k’ to represent a particular purchase.

To apply temporal dynamics to the click data 202 and the conversion data 204 for predictions, the temporal prediction model 104 may implement various algorithms to solve one or more objective functions. In one specific example, the objective function:

Objective Function 1:

$$arg {min}_{{U}^{t} , {V}^{t} , {P}^{t} , M} f ( {U}^{t} , {V}^{t} , {P}^{t} , M ) = α {‖ {W}^{C} ⊙ ( {C}^{t} - {U}^{t} {V}^{tT} ) ‖}_{F}^{2} + ( 1 - α ) ( {‖ {W}^{D} ⊙ ( {D}^{t} - {U}^{t} {P}^{tT} ) ‖}_{F}^{2} + {‖ {W}^{D} ⊙ ( {D}^{t} - {U}^{t - 1} {MP}^{tT} ) ‖}_{F}^{2} ) + λ ( {‖ {U}^{t} ‖}_{F}^{2} + {‖ {V}^{t} ‖}_{F}^{2} + {‖ {P}^{t} ‖}_{F}^{2} + {‖ M ‖}_{F}^{2} ) ,$$

is solved using the equations:

$$\begin{matrix}{u}_{i}^{t} = {u}_{i}^{t} - γ \frac{\partial }{\partial {u}_{i}^{t}} f ( {U}^{t} , {V}^{t} , {P}^{t} , M ) & ( 1 ) \\ \frac{\partial f}{\partial {u}_{i}^{t}} = - ∝ {\sum }_{( i , j ) ∈ ϑ} ( {c}_{i , j}^{t} - {u}_{i}^{t} {v}_{j}^{tT} ) {v}_{j}^{t} - ( 1 - ∝ ) {\sum }_{( i , k ) ∈ ϑ} ( {d}_{i , k}^{t} - {u}_{i}^{t} {p}_{k}^{tT} ) {p}_{k}^{t} + λ {u}_{i}^{t} & ( 2 ) \\ {v}_{j}^{t} = {v}_{j}^{t} - γ \frac{\partial }{\partial {v}_{j}^{t}} f ( {U}^{t} , {V}^{t} , {P}^{t} , M ) & ( 3 ) \\ \frac{\partial f}{\partial {v}_{j}^{t}} = - ∝ {\sum }_{( i , j ) ∈ ϑ} ( {c}_{i , j}^{t} - {u}_{i}^{t} {v}_{j}^{tT} ) {u}_{i}^{t} + λ {v}_{j}^{t} & ( 4 ) \\ {p}_{k}^{t} = {p}_{k}^{t} - γ \frac{\partial }{\partial {p}_{k}^{t}} f ( {U}^{t} , {V}^{t} , {P}^{t} , M ) & ( 5 ) \\ \frac{\partial f}{\partial {p}_{k}^{t}} = - ( 1 - ∝ ) ( {\sum }_{( i , k ) ∈ ϑ} ( {d}_{i , k}^{t} - {u}_{i}^{t} {p}_{k}^{tT} ) {u}_{i}^{t} + ( {d}_{i , k}^{t} - {u}_{i}^{t - 1} {Mp}_{k}^{tT} ) {u}_{i}^{t - 1} M ) + λ {p}_{k}^{t} & ( 6 ) \\ M = M - γ \frac{\partial }{\partial M} f ( M ) . & ( 7 )\end{matrix}$$

These equations are employed by an algorithm to solve objective function 1 above.

Algorithm 1:

Input: click response C^{t}, purchase activity D^{t}, latent features U^{t-1}

Initialize: γ, ∝, λ, M=I.

Output: latent features U^{t}, V^{t} and P^{t}
1: while not converged do
2: Select a pair of training points cᵢⱼ^{t}εC^{t} and dᵢₖ^{t}εD^{t} uniformly at random.
3: Update latent vector uᵢ using (1) and (2).
4: Update latent vector vⱼ using (3) and (4).
5: Update latent vector pₖ using (5) and (6).
6: Update transition matrix M using (7).
7: end while
   Thus, in this specific example, the temporal prediction model 104 uses algorithm 1 to apply temporal dynamics to the click data 202 and the conversion data 204 for predictions. In this way, the temporal prediction model 104 may be utilized to predict metrics 210 even in instances in which the side information 206 is not processed.

In implementations that further process the side information 206, the temporal prediction model 104 may apply temporal dynamics by implementing various algorithms to solve one or more objective functions. In one specific example, the objective function:

Objective Function 2:

$$arg {min}_{\begin{matrix}{U}^{t} , {V}^{t} , {P}^{t} , M , \\ {\hat{U}}^{t} , {\hat{V}}^{t} {\hat{P}}^{t}\end{matrix}} α {‖ {W}^{C} ⊙ ( {C}^{t} - {U}^{i} {V}^{tT} - {\hat{U}}^{i} {Y}^{T} - X {\hat{V}}^{tT} ) ‖}_{F}^{2} + ( 1 - α ) ( {‖ {W}^{D} ⊙ ( {D}^{t} - {U}^{t} {P}^{iT} - {\hat{U}}^{t} {Z}^{T} - X {\hat{P}}^{tT} ) ‖}_{F}^{2} + {‖ {W}^{D} ⊙ ( {D}^{t} - {U}^{t - 1} {MP}^{tT} - {\hat{U}}^{t} {Z}^{T} - X {\hat{P}}^{tT} ) ‖}_{F}^{2} ) + λ ( {‖ {U}^{t} ‖}_{F}^{2} + {‖ {V}^{t} ‖}_{F}^{2} + {‖ {P}^{t} ‖}_{F}^{2} + {‖ M ‖}_{F}^{2} ) .$$

is solved using the equations:

$$\begin{matrix}\frac{\partial f}{\partial {u}_{i}^{t}} = - ∝ {\sum }_{( i , j ) ∈ ϑ} ( {c}_{i , j}^{t} - {u}_{i}^{t} {v}_{j}^{tT} - {\hat{u}}_{i}^{t} {y}_{j}^{T} - {x}_{i} {\hat{v}}_{j}^{tT} ) {v}_{j}^{t} - ( 1 - ∝ ) {\sum }_{( i , k ) ∈ ϑ} ( {d}_{i , k}^{t} - {u}_{i}^{t} {p}_{k}^{tT} - {\hat{u}}_{i}^{t} {z}_{jk}^{T} - {x}_{i} {\hat{p}}_{k}^{tT} ) {p}_{k}^{t} + λ {u}_{i}^{t} & ( 8 ) \\ \frac{\partial f}{\partial {v}_{j}^{t}} = - ∝ {\sum }_{( i , j ) ∈ ϑ} ( {c}_{i , j}^{t} - {u}_{i}^{t} {v}_{j}^{tT} - {\hat{u}}_{i}^{t} {y}_{j}^{T} - {x}_{i} {\hat{v}}_{j}^{tT} ) {u}_{i}^{t} + λ {v}_{j}^{t} & ( 9 ) \\ \frac{\partial f}{\partial {p}_{k}^{t}} = - ( 1 - ∝ ) ( {\sum }_{( i , k ) ∈ ϑ} ( {d}_{i , k}^{t} - {u}_{i}^{t} {p}_{k}^{tT} - {\hat{u}}_{i}^{t} {z}_{k}^{T} - {x}_{i} {\hat{p}}_{k}^{tT} ) {u}_{i}^{t} + ( {d}_{i , k}^{t} - {u}_{i}^{t - 1} {Mp}_{k}^{tT} - {\hat{u}}_{i}^{t} {z}_{k}^{T} - {x}_{i} {\hat{p}}_{k}^{tT} ) {u}_{i}^{t - 1} M ) + λ {p}_{k}^{t} & ( 10 ) \\ \frac{\partial f}{\partial {\hat{u}}_{i}^{t}} = - ∝ {\sum }_{( i , j ) ∈ ϑ} ( {c}_{i , j}^{t} - {u}_{i}^{t} {v}_{j}^{tT} - {\hat{u}}_{i}^{t} {y}_{j}^{T} - {x}_{i} {\hat{v}}_{j}^{tT} ) {y}_{j} - ( 1 - ∝ ) {\sum }_{( i , k ) ∈ ϑ} ( {d}_{i , k}^{t} - {u}_{i}^{t} {p}_{k}^{tT} - {\hat{u}}_{i}^{t} {z}_{jk}^{T} - {x}_{i} {\hat{p}}_{k}^{tT} ) {y}_{k} + ( {d}_{i , k}^{t} - {u}_{i}^{t - 1} {Mp}_{k}^{tT} - {\hat{u}}_{i}^{t} {z}_{k}^{T} - {x}_{i} {\hat{p}}_{k}^{tT} ) {z}_{k} ) + λ {\hat{u}}_{i}^{t} & ( 11 ) \\ \frac{\partial f}{\partial {\hat{v}}_{j}^{t}} = - ∝ {\sum }_{( i , j ) ∈ ϑ} ( {c}_{i , j}^{t} - {u}_{i}^{t} {v}_{j}^{tT} - {\hat{u}}_{i}^{t} {y}_{j}^{T} - {x}_{i} {\hat{v}}_{j}^{tT} ) {x}_{i} + λ {\hat{v}}_{j}^{t} & ( 12 ) \\ \frac{\partial f}{\partial {\hat{p}}_{k}^{t}} = - ( 1 - ∝ ) ( {\sum }_{( i , k ) ∈ ϑ} ( {d}_{i , k}^{t} - {u}_{i}^{t} {p}_{k}^{tT} - {\hat{u}}_{i}^{t} {z}_{k}^{T} - {x}_{i} {\hat{p}}_{k}^{tT} ) {x}_{i} + ( {d}_{i , k}^{t} - {u}_{i}^{t - 1} {Mp}_{k}^{tT} - {\hat{u}}_{i}^{t} {z}_{k}^{T} - {x}_{i} {\hat{p}}_{k}^{tT} ) {x}_{i} ) + λ {\hat{p}}_{k}^{t} & ( 13 ) \\ \frac{\partial f}{\partial M} = - ( 1 - ∝ ) {U}^{( t - 1 ) T} ( {W}^{D} ⊙ ( {D}^{t} - {U}^{( t - 1 )} {MP}^{tT} - {\hat{U}}^{t} {Z}^{T} - X {\hat{P}}^{tT} ) {P}^{t} ) . & ( 14 )\end{matrix}$$

These equations are employed by an algorithm to solve objective function 2 above.

Algorithm 2:
Input: click response C^{t}, purchase activity D^{t}, user features X, advertisement features Y, item features Z, latent features U^{t-1}
Initialize: γ=0.003, ∝=0.5, λ=0.02, M=I.
Output: latent features U^{t}, V^{t}, P^{t}, Û^{t}, \hat{V}^{t} and \hat{P}^{t}
   1: while not converged do
   2: Select a pair of training points cᵢⱼ^{t}εC^{t} and dᵢₖ^{t}εD^{t} uniformly at random.
   3: Update latent vector uᵢ using (8),

$${u}_{i}^{t} = {u}_{i}^{t} - γ \frac{\partial f}{\partial {u}_{i}^{t}} .$$

4: Update latent vector vⱼ using (9),

$${v}_{j}^{t} = {v}_{j}^{t} - γ \frac{\partial f}{\partial {v}_{j}^{t}} .$$

5: Update latent vector pₖ using (10),

$${p}_{k}^{t} = {p}_{k}^{t} - γ \frac{\partial f}{\partial {p}_{k}^{t}} .$$

6: Update regression coefficients ûᵢ using (11),

$${\hat{u}}_{i}^{t} = {\hat{u}}_{i}^{t} - γ \frac{\partial f}{\partial {\hat{u}}_{i}^{t}} .$$

7: Update regression coefficients \hat{v}ⱼ using (12),

$${\hat{v}}_{j}^{t} = {\hat{v}}_{j}^{t} - γ \frac{\partial f}{\partial {\hat{v}}_{j}^{t}} .$$

8: Update regression coefficients \hat{p}ₖ using (13),

$${\hat{p}}_{k}^{t} = {\hat{p}}_{k}^{t} - γ \frac{\partial f}{\partial {\hat{p}}_{k}^{t}} .$$

9: Update transition matrix M using (14).
10: end while
   Thus, in this specific example, the temporal prediction model 104 uses algorithm 2 to apply temporal dynamics to the click data 202, the conversion data 204, and the side information 206 for predictions. In this way, the temporal prediction model 104 may be utilized to predict metrics 210 in instances that include processing the side information 206. In other examples, the initialization parameters γ, ∝, and λ, in algorithm 2 may be adjusted for different data sets based on one or more attributes of each data set.

Without loss of generality, only two algorithms are considered here as an example, however, in another example, the temporal prediction model 104 may form predictions by implementing additional or similar algorithms, equations, and/or objective functions.

As illustrated in FIG. 2, the predicted metrics include by way of example, predictions of purchase behavior, whether an ad will be selected by a user when subsequently presented, whether a conversion will occur in response to selecting an ad, whether a conversion will occur in response to viewing (but not selecting) an ad, and/or revenue potential associated with presenting a future ad.

Various actions such as obtaining, generating, forming, predicting, assigning, processing and so forth performed by various modules are discussed herein. It should be appreciated that the various modules may be configured in various combinations with functionality to cause these and other actions to be performed. Functionality associated with a particular module may be further divided among different modules and/or the functionality represented by multiple modules may be combined together into a single logical module. Moreover, a particular module may be configured to cause performance of action directly by the particular module. In addition or alternatively the particular module may cause particular actions by invoking or otherwise accessing other components or modules to perform the particular actions (or perform the actions in conjunction with that particular module).

### Example Procedures

The following discussion describes prediction techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. Moreover, any one or more blocks of the procedure may be combined together or omitted entirely in different implementations. Moreover, blocks associated with different representative procedures and corresponding figures herein may be applied together. Thus, the individual operations specified across the various different procedures may be used in any suitable combinations and are not limited to the particular combinations represented by the example figures. In portions of the following discussion, reference may be made to the examples of FIGS. 1 and 2.

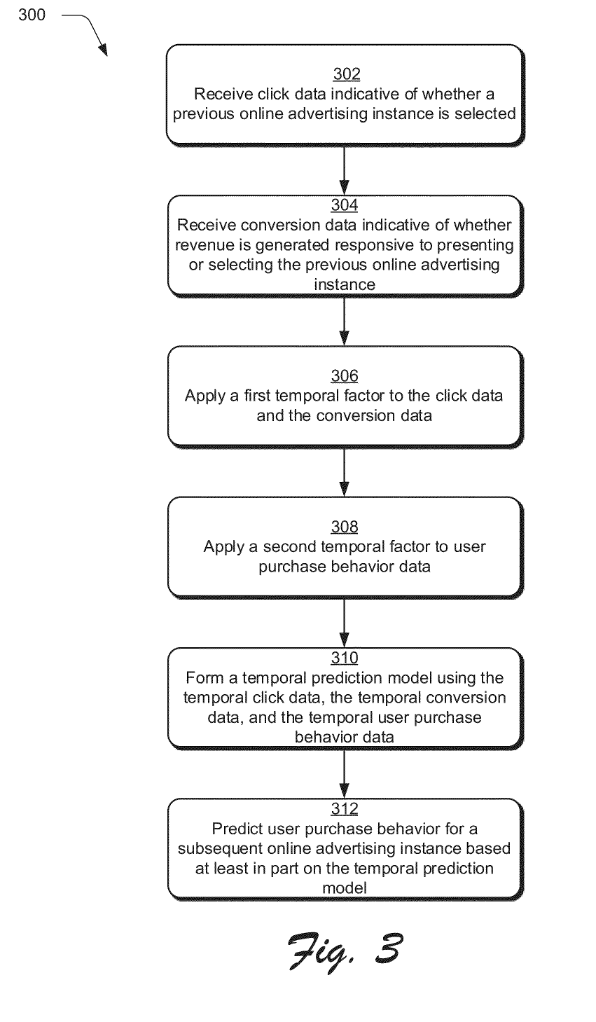

FIG. 3 is a flow diagram depicting a procedure 300 in which the temporal prediction model predicts user purchase behavior. In at least some implementations, procedure 300 may be performed by a suitably configured computing device such as computing device 102 of FIG. 1 having a temporal prediction model 104 or as described in relation to FIG. 6.

Click data indicative of whether a previous online advertising instance is selected and conversion data indicative of whether revenue is generated responsive to presenting or selecting the previous online advertising instance is received (blocks 302 and 304). For example, the computing device 102 may receive the click data and the conversion data using any of the techniques described herein. In one or more implementations, the click data and the conversion data may be representative of tracking data provided by the monitoring service 112.

A first temporal factor is applied to the click data and the conversion data (block 306). For instance, the computing device 102 may implement the temporal prediction model 104 using any of the techniques described herein. In one or more implementations, applying the first temporal factor to the click data and the conversion data includes filtering the click data and the conversion data by a time value representative of a relationship between presentation of the previous online advertising instance and conversion of the previous online advertising instance.

A second temporal factor is applied to user purchase behavior data (block 308). For instance, the computing device 102 may implement the temporal prediction model 104 to apply a time window to the user purchase behavior data. Here, the user purchase behavior data describes past purchases made by a particular user.

A temporal prediction model is formed using the temporal click data, the temporal conversion data, and the temporal user purchase behavior data (block 310). For instance, the temporal click data, the temporal conversion data, and the temporal user purchase behavior data are processed for inclusion in the temporal prediction model 104, examples of which are described previously.

User purchase behavior is predicted for a subsequent online advertising instance based at least in part on the temporal prediction model (block 312). For instance, predicted metrics describing whether or not a user will select and/or convert the subsequent online advertising instance are generated by the temporal prediction model 104. In one or more implementations, the predicted metrics may be shared with advertisers to improve a rate of return on their advertising investments.

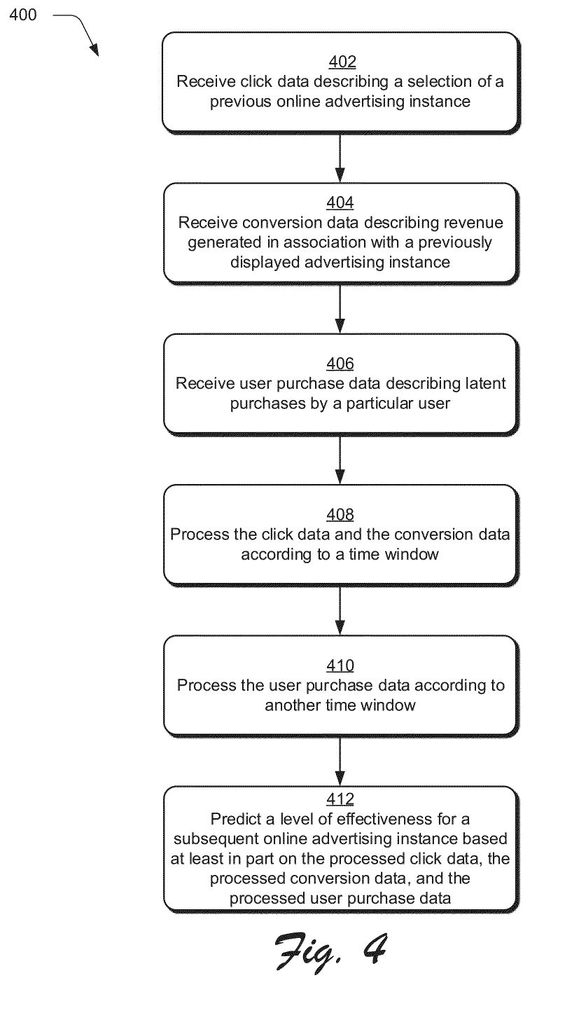

Having considered an example procedure in which the temporal prediction model predicts user purchase behavior, consider now a procedure 400 in FIG. 4 that depicts an example for predicting a level of effectiveness for an online advertising instance based on processing data according to two time windows. In at least some implementations, procedure 400 may be performed by a suitably configured computing device such as computing device 102 of FIG. 1 and/or computing device 602 of FIG. 6.

Click data describing a selection of a previous online advertising instance, conversion data describing revenue generated in association with the previous online advertising instance, and user purchase data describing latent purchases by a particular user is received (blocks 402, 404, and 406). For example, the computing device 102 may receive the click data, the conversion data, and the user purchase data using any of the techniques described herein.

The click data and the conversion data are processed according to a time window (block 408). For example, the temporal factorization module 116 processes the click data and the conversion data according to the amount of time between a click and a conversion of the previous online advertising instance. In this example, the temporal factorization module 116 filters the click data and the conversion data according to a time frame corresponding to the time window.

The user purchase data is processed according to another time window (block 410). For example, the temporal factorization module 116 processes the user purchase data according to the amount of time that encapsulates a given set of purchases. Here, the user purchase data may describes purchased items related to converted items as described by the conversion data.

A level of effectiveness for a subsequent online advertising instance is predicted based at least in part on the processed click data, the processed conversion data, and the processed user purchase data (block 412). Here, the processed data may be used to form the temporal prediction model 104. To determine effectiveness, for example, the temporal prediction model 104 may use a predicted metric for the previous online advertising instance to assess whether a user is likely to convert a subsequent online advertising instance having related content.

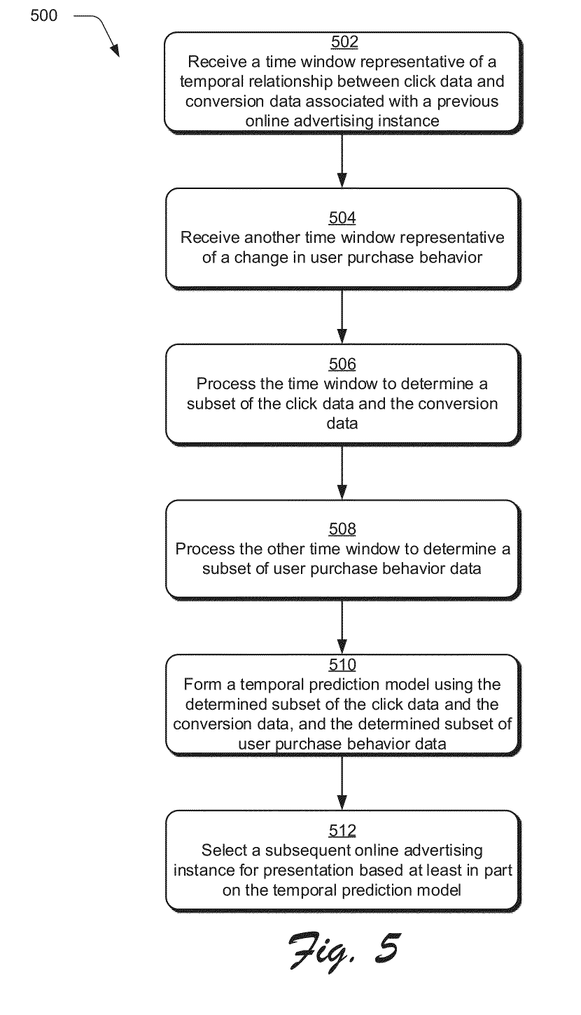

Having considered an example procedure that depicts predicting a level of effectiveness for an online advertising instance based on the temporal prediction model, consider now a procedure 500 in FIG. 5 that depicts an example for forming a temporal prediction model using a subset of data determined by processing multiple time windows. In at least some implementations, procedure 500 may be performed by a suitably configured computing device such as computing device 102 of FIG. 1 and/or computing device 602 of FIG. 6.

A time window is received that is representative of a temporal relationship between click data and conversion data associated with a previous online advertising instance (block 502). For example, the temporal prediction model 104 receives a time value indicative of an amount of time between a click or an impression of an online advertising instance and a conversion corresponding to the online advertising instance.

Another time window is received, this one representative of a change in user purchase behavior (block 504). For example, the temporal prediction model 104 receives a time value that corresponds to a set of purchases of related and/or unrelated items.

The time window is processed to determine a subset of the click data and the conversion data (block 506). For example, only the click and conversion data corresponding to the time window is used for predictions thereby reducing computational latency incurred by the computing device 102 relative to processing all the click and conversion data.

The other time window is processed to determine a subset of user purchase behavior data (block 508). For example, user purchase behavior data corresponding to the other time window is used for predictions thereby reducing computational latency incurred by the computing device 102 relative to processing all the past purchases by a user.

A temporal prediction model is formed using the determined subset of the click data, the conversion data, and the determined subset of user purchase behavior data (block 510). The temporal prediction model 104 may be formed, for instance, using the techniques described herein. In some instances, forming the temporal prediction model 104 may include performing various processing techniques that lead to a prediction for an online advertising instance.

A subsequent online advertising instance is selected for presentation based at least in part on the temporal prediction model (block 512). For instance, the temporal prediction model 104 may use one or more of the predicted metrics 210 to select a subsequent online advertising instance for presentation on the computing device 102. In one or more implementations, the subsequent online advertising instance is selected from a set of available advertisements based on a likelihood that a user will purchase an item in the subsequent online advertising instance.

### Example System and Device

FIG. 6 illustrates an example system 600 that, generally, includes an example computing device 602 that is representative of one or more computing systems and/or devices that may implement the various techniques described herein. This is illustrated through inclusion of the temporal prediction model 104. The computing device 602 may be, for example, a server of a service provider, a device associated with a client (e.g., a client device), an on-chip system, and/or any other suitable computing device or computing system.

The example computing device 602 as illustrated includes a processing system 604, one or more computer-readable media 606, and one or more I/O interface 608 that are communicatively coupled, one to another. Although not shown, the computing device 602 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 604 is representative of functionality to perform one or more operations using hardware. Accordingly, the processing system 604 is illustrated as including hardware element 610 that may be configured as processors, functional blocks, and so forth. This may include implementation in hardware as an application specific integrated circuit or other logic device formed using one or more semiconductors. The hardware elements 610 are not limited by the materials from which they are formed or the processing mechanisms employed therein. For example, processors may be comprised of semiconductor(s) and/or transistors, e.g., electronic integrated circuits (ICs). In such a context, processor-executable instructions may be electronically-executable instructions.

The computer-readable storage media 606 is illustrated as including memory/storage 612. The memory/storage 612 represents memory/storage capacity associated with one or more computer-readable media. The memory/storage component 612 may include volatile media (such as random access memory (RAM)) and/or nonvolatile media (such as read only memory (ROM), Flash memory, optical disks, magnetic disks, and so forth). The memory/storage component 612 may include fixed media (e.g., RAM, ROM, a fixed hard drive, and so on) as well as removable media, e.g., Flash memory, a removable hard drive, an optical disc, and so forth. The computer-readable media 606 may be configured in a variety of other ways as further described below.

Input/output interface(s) 608 are representative of functionality to allow a user to enter commands and information to computing device 602, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 602 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 602. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 602, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 610 and computer-readable media 606 are representative of modules, programmable device logic and/or fixed device logic implemented in a hardware form that may be employed in one or more implementations to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 610. The computing device 602 may be configured to implement particular instructions and/or functions corresponding to the software and/or hardware modules. Accordingly, implementation of a module that is executable by the computing device 602 as software may be achieved at least partially in hardware, e.g., through use of computer-readable storage media and/or hardware elements 610 of the processing system 604. The instructions and/or functions may be executable/operable by one or more articles of manufacture (for example, one or more computing devices 602 and/or processing systems 604) to implement techniques, modules, and examples described herein.

The techniques described herein may be supported by various configurations of the computing device 602 and are not limited to the specific examples of the techniques described herein. This functionality may also be implemented all or in part through use of a distributed system, such as over a “cloud” 614 via a platform 616 as described below.

The cloud 614 includes and/or is representative of a platform 616 for resources 618. The platform 616 abstracts underlying functionality of hardware (e.g., servers) and software resources of the cloud 614. The resources 618 may include applications and/or data that can be utilized while computer processing is executed on servers that are remote from the computing device 602. Resources 618 can also include services provided over the Internet and/or through a subscriber network, such as a cellular or Wi-Fi network.

The platform 616 may abstract resources and functions to connect the computing device 602 with other computing devices. The platform 616 may also serve to abstract scaling of resources to provide a corresponding level of scale to encountered demand for the resources 618 that are implemented via the platform 616. Accordingly, in an interconnected device embodiment, implementation of functionality described herein may be distributed throughout the system 600. For example, the functionality may be implemented in part on the computing device 602 as well as via the platform 616 that abstracts the functionality of the cloud 614.

### CONCLUSION

Although the techniques have been described in language specific to structural features and/or methodological acts, it is to be understood that the subject matter defined in the appended claims is not necessarily limited to the specific features or acts described. Rather, the specific features and acts are disclosed as example forms of implementing the claimed subject matter.

What is claimed is:

1. In a digital medium environment for online advertising and prediction of subsequent user behavior in relation to the online advertising that addresses changing user interests and purchase behaviors over time, a method comprising:
receiving click data indicative of whether a previous online advertising instance is selected;
receiving conversion data indicative of whether revenue is generated responsive to presenting or selecting the previous online advertising instance;
applying a first temporal factor to the click data and the conversion data;
applying a second temporal factor to user purchase behavior data;
forming a temporal prediction model using the temporal click data, the temporal conversion data, and the temporal user purchase behavior data; and
predicting user purchase behavior for a subsequent online advertising instance based at least in part on the temporal prediction model.

2. A method as described in claim 1, wherein the first temporal factor and the second temporal factor represent two consecutive time frames.

3. A method as described in claim 1, wherein the first temporal factor includes a time value representing a relationship between presentation of the previous online advertising instance and conversion of the previous online advertising instance the applying the temporal factor to the click data and the conversion data includes filtering the click data and the conversion data by the time value.

4. A method as described in claim 1, further comprising using the temporal prediction model to measure effectiveness of the previous online advertising instance.

5. A method as described in claim 1, wherein the predicting the user purchase behavior includes predicting revenue from a post-click conversion or a post-impression conversion associated with the subsequent online advertising instance

6. A method as described in claim 1, wherein the predicting the user purchase behavior includes predicting whether a user will click on the subsequent online advertising instance.

7. A method as described in claim 1, wherein the forming the temporal prediction model is based, at least in part, on applying a stochastic gradient descent algorithm to the click data and the conversion data.

8. In a digital medium environment for selecting online advertising instances based on prediction of subsequent user behavior that addresses changing user interests and purchase behaviors over time, a method comprising:
identifying a temporal relationship between click data and conversion data associated with a previous online advertising instance;
identifying a time window based on the identified temporal relationship;
using the identified time window to determine a subset of the click data and the conversion data;
performing dynamic collective matrix factorization using the determined subset of the click data and the conversion data such that the click data and the conversion data are jointly processed to predict a subsequent online advertising instance for presentation; and
selecting a subsequent online advertising instance for presentation based at least in part on the prediction performed by the dynamic collective matrix factorization.

9. A method as described in claim 8, further comprising mapping user purchase behavior in two time windows and applying the mapping to the dynamic collective matrix factorization.

10. A method as described in claim 8, wherein the temporal relationship between the click data and the conversion data is based at least in part on a change in a number of conversions over a particular time.

11. A method as described in claim 8, wherein the click data indicates that a user did not select the previous online advertising instance presented in a user interface and the conversion data indicates that the user performed a conversion associated with the previous online advertising instance.

12. A method as described in claim 8, wherein the using the identified time window to determine the subset of the click data and the conversion data includes processing the click data and the conversion data that corresponds to the identified time window.

13. A method as described in claim 8, further comprising dynamically adjusting the temporal prediction model to another identified time window.

14. A method as described in claim 8, wherein the time window includes a time value between receiving a selection of the previous online advertising instance and identifying a conversion for the selected previous online advertising instance.

15. A system for online advertising and prediction of subsequent user behavior in relation to the online advertising that addresses changing user interests and purchase behaviors over time, the system comprising:
one or more processors; and
memory, communicatively coupled to the one or more processors,
a data processor module stored in the memory and executable by the one or more processors to:
receive click data describing a selection of a previous online advertising instance;
receive conversion data describing revenue generated in association with a previously displayed advertising instance; and
receive user purchase data describing latent purchases by a particular user;
a temporal factorization module stored in the memory and executable by the one or more processors to:
process the click data and the conversion data according to a time window, the time window being based on a temporal relationship between the click data and the conversion data; and
process the user purchase data according to another time window, the other time window being associated with the time window; and
a prediction module stored in the memory and executable by the one or more processors to predict a level of effectiveness for a subsequent online advertising instance based at least in part on the processed click data, the processed conversion data, and the processed user purchase data.

16. A system as described in claim 15, wherein to process the click data and the conversion data according to the time window includes to filter the click data and the conversion data according to a time frame corresponding to the time window.

17. A system as described in claim 15, wherein the temporal relationship between the click data and the conversion data is representative of an identified change in user purchase behavior over a particular time period.

18. A system as described in claim 15, wherein the processed click data, the processed conversion data, and the processed user behavior data are used to create a temporal prediction model.

19. A system as described in claim 18, wherein to create the temporal prediction model includes to leverage one or more of user information, advertiser information, and advertisement item information.

20. A system as described in claim 15, wherein the time window and the other time window are a same duration of time.
